(19) United States
(12) Patent Application Publication
(10) Pub. No.: US 2026/0129561 A1
(43) Pub. Date: May 7, 2026

(54) METHOD AND APPARATUS FOR SESSION MANAGEMENT

(71) Applicant: Telefonaktiebolaget LM Ericsson (publ), Stockholm (SE)

(72) Inventors: Hongtao LI, Guangzhou (CN); Jingrui TAO, Guangzhou (CN)

(73) Assignee: Telefonaktiebolaget LM Ericsson (publ), Stockholm (SE)

(21) Appl. No.: 19/114,692

(22) PCT Filed: Sep. 27, 2023
(86) PCT No.: PCT/CN2023/121945

§ 371 Date: Mar. 24, 2025

(30) Foreign Application Priority Data
Sep. 30, 2022 (WO) PCT/CN2022/123264

(51) Int. Cl. H04W 48/16; H04W 8/20; H04W 12/06; H04W 28/24

(52) U.S. Cl. CPC H04W 48/16; H04W 8/20; H04W 12/06; H04W 28/24

(57) ABSTRACT

Embodiments of the present disclosure provide method and apparatus for session management. A method performed by a first network node comprises receiving a first event exposure notify message from a second network node. The first event exposure notify message comprises a user equipment (UE) Internet protocol (IP) address and an IP domain of the UE IP address.

### TECHNICAL FIELD

The non-limiting and exemplary embodiments of the present disclosure generally relate to the technical field of communications, and specifically to methods and apparatuses for session management.

### BACKGROUND

This section introduces aspects that may facilitate a better understanding of the disclosure. Accordingly, the statements of this section are to be read in this light and are not to be understood as admissions about what is in the prior art or what is not in the prior art.

Clause 4.2.2.2 of 3rd Generation Partnership Project (3GPP) TS 29.514 V17.2.0, the disclosure of which is incorporated by reference herein in its entirety, describes same Internet protocol (IP) address can be allocated to user equipment (UE) protocol data unit (PDU) sessions served by SMF(Session Management Function)/UPF(s)(User plane Function) in different address domains.

Within a network slice, there may be several separate IP address domains, with SMF/UPF(s) that allocate Ipv4 (IP version 4) IP addresses out of the same private address range to UE PDU Sessions. The same IP address can thus be allocated to UE PDU sessions served by SMF/UPF(s) in different address domains. If a Policy Control Function (PCF) controls several SMF/UPF(s) in different IP address domains, the UE IP address is thus not sufficient for the session binding. A network function (NF) service consumer can serve UEs in different IP address domains, either by having direct IP interfaces to those domains, or by having interconnections via Network Address Translations (NATs) in the user plane between the UPF and the network function (NF) service consumer. If a NAT is used, the NF service consumer obtains the IP address allocated to the UE PDU session via application level signaling and supplies it for the session binding to the PCF in the “ueIpv4” attribute. The NF service consumer supplies an “ipDomain” attribute denoting the IP address domain behind the NAT in addition. The NF service consumer can derive the appropriate value from the source address (allocated by the NAT) of incoming user plane packets. The value provided in the “ipDomain” attribute is operator configurable.

Edge computing is a concept that enables services to be hosted close to the service consumers and provides benefits such as efficient service delivery with significant reduction in end-to-end latency and decreased load on the transport network. The benefits of edge computing will strengthen the promise of 5G (fifth generation) and expand the prospects for several new and enhanced use cases—including virtual and augmented reality, Internet of Things (IoT), Industrial IoT, autonomous driving, real-time multiplayer gaming, etc.

3rd Generation Partnership Project (3GPP) TS 23.558 V17.4.0, the disclosure of which is incorporated by reference herein in its entirety, specifies application layer architecture, procedures and information flows necessary for enabling edge applications over 3GPP networks. It includes architectural requirements for enabling edge applications, application layer architecture fulfilling the architecture requirements and procedures to enable the deployment of edge applications.

FIG. 1a shows a reference point representation of architecture for edge enabling applications according to an embodiment of the present disclosure. FIG. 1a is same as FIG. 6.2-4 of 3GPP TS 23.558 V17.4.0. The Edge Data Network (EDN) is a local Data Network. Edge Application Server(s) and the Edge Enabler Server are contained within the EDN. The Edge Configuration Server provides configurations related to the EES, including details of the Edge Data Network hosting the (edge enabler server). The UE contains Application Client(s) (ACs) and the Edge Enabler Client (EEC). The Edge Application Server(s), the Edge Enabler Server and the Edge Configuration Server may interact with the 3GPP core network.

The functional entities include:

Edge Enabler Server (EES): EES provides supporting functions needed for EASs and EEC, e.g., EEC registration, EAS discovery and network APIs for EAS and service continuity support.

Edge Enabler Client (EEC): EEC provides supporting functions needed for AC(s), e.g., retrieval and provisioning of configuration information to enable application data traffic, and EAS discovery.

Edge Configuration Server (ECS): ECS provides supporting functions needed for the EEC to connect with an EES, e.g., provisioning of Edge configuration information to the EEC, and EES discovery.

Application Client (AC): AC is the application resident in the UE performing the client function.

Edge Application Server (EAS): EAS is the application server resident in the EDN, performing the server functions. The AC connects to the EAS in order to avail the services of the application with the benefits of Edge Computing.

Note: EDGE reference point explanation can be found in clause 6.5 of 3GPP TS 23.558 V17.4.0.

As described in clause 8.6.6 of 3GPP TS 23.558 V17.4.0, the EES exposes the Session with quality of service (QoS) application programming interface (API) to the EAS in order to support the setup of a data session between AC and EAS with a specific QoS and the modification of the QoS of this data session.

FIG. 1b shows a flowchart of the session with QoS create operation between the EAS and the EES, which is same as FIG. 8.6.6.2.2-1 of 3GPP TS 23.558 V17.4.0. It is used to request reservation of resources for a data session between AC and EAS with a specific QoS and to subscribe to certain session with QoS event notifications.

The steps of FIG. 1b are described in clause 8.6.6.2.2 of 3GPP TS 23.558 V17.4.0 as below.
1. The EAS requests establishment of a data session between the AC and the EAS with a specific QoS (either QoS reference or bandwidth). If the data session can adjust to different QoS parameter combinations, the request may include a list of alternative QoS references in a priority order. The EAS shall include the UE's IP address, UE ID or UE Group ID, the DNN and S-NSSAI used for the data session between AC and EAS. With the same request the EAS subscribes to receive certain session with QoS event notifications (e.g. notifications related to QoS monitoring, usage monitoring for sponsored data connectivity and/or QoS targets can no longer (or can again) be fulfilled).
2. The EES checks if the EAS is authorized for this operation for the UE. If authorized, then the following services of 3GPP CN may be used by the EES:
   a. the EES invokes the Event Monitoring service for PDU session status with the 3GPP Core Network, as described in 3GPP TS 23.502 [3].
   b. the EES invokes the Policy Authorization Create service or the AF Session with QoS service with the 3GPP Core Network (PCF or NEF, respectively) as described in 3GPP TS 23.501 [2] and 3GPP TS 23.502 [3], providing the specific QoS (QoS reference or bandwidth) to the PCF as described in 3GPP TS 23.503 [12], clause 6.1.3.22. Additionally, the EES may subscribe to notifications of resource allocation outcome and to other events described in clause 6.1.3.18 of 3GPP TS 23.503 [12], e.g. notifications of when the QoS targets can no longer (or can again) be fulfilled.

The usage of step 2a and step 2b is as follows:
If the request is for a group of UEs identified by the UE Group ID or for a single UE identified by the UE ID, then EES executes step 2a. If UE (single UE or UE group member) already has ongoing PDU session, then UE IP address is retrieved in step 2a. Further the EES executes step 2b; otherwise the EES waits for further notification for PDU session status in step 4.
If the request is for a single UE identified by the IP address, then EES executes step 2b.
3. If the operation in step 2 is successful, the EES responds with a Context ID and a Result. The Context ID is to be used by the EAS for further requests (e.g. session with QoS update requests) pertaining to the same UE. If the EAS is not authorized or any other failure happens during the operation, the EES provides a rejection response with cause information.
4. When the EES receives the corresponding UE IP address for the single UE or UE group member from the PDU session status notification sent by the 3GPP Core Network, the EES requests data session with specific QoS as described in step 2b.

NOTE: The EES will report the resource allocation outcome, e.g. the successful allocation of the Service Data Flow(s) related to the data session, with a separate session with QoS notify operation (see TS 23.503 [12], clause 6.1.3.18).

As described in clause 4.15.6.6 of 3GPP TS 23.502 V17.5.0, an application function (AF) can send a request to reserve resources for an AF session using Nnef_AFsessionWithQoS_Create request message to set up an AF session with required QoS.

### Monitoring Event

The Monitoring Events feature is intended for monitoring of specific events in 3GPP system and making such monitoring events information reported via the NEF (Network Exposure Function). It is comprised of means that allow NFs in 5GS (fifth generation system) for configuring the specific events, the event detection, and the event reporting to the requested party.

FIG. 1c shows a flowchart of Nnef_EventExposure_Subscribe, Unsubscribe and Notify operations, which is same as FIG. 4.15.3.2.3-1 of 3GPP TS 23.502 V17.5.0. The procedure is used by the AF to subscribe to event notifications, to modify group-based subscriptions to event notification and to explicitly cancel a previous subscription. Cancelling is done by sending Nnef_EventExposure_Unsubscribe request identifying the subscription to cancel with Subscription Correlation ID. The notification steps 6 to 8 are not applicable in cancellation case.

The steps of FIG. 1c are described in clause 4.15.3.2.3 of 3GPP TS 23.502 V17.5.0 as below.
1. The AF subscribes to one or several Event(s) (identified by Event ID) and provides the associated notification endpoint of the AF by sending Nnef_EventExposure_Subscribe request.

Event Reporting Information defines the type of reporting requested (e.g. one-time reporting, periodic reporting or event based reporting, for Monitoring Events). If the reporting event subscription is authorized by the NEF, the NEF records the association of the event trigger and the requester identity. The subscription may also include Maximum number of reports and/or Maximum duration of reporting IE and optionally MTC Provider Information.

If subscription to group-based event notifications are removed or added for certain UEs in a group of UEs for which there is an event notification subscription, the AF provides impacted UE information (e.g. SUPI, MSISDN or External Identity) with operation indication which is either cancellation or addition to NEF via Nnef_EventExposure_Subscribe without cancelling the entire group-based event notification subscription.
2. [Conditional—depending on authorization in step 1] The NEF subscribes to received Event(s) (identified by Event ID) and provides the associated notification endpoint of the NEF to UDM by sending Nudm_EventExposure_Subscribe request. The NEF may either receive DNN, S-NSSAI from AF in step 1 or maps the AF-Identifier into DNN and S-NSSAI combination based on local configuration and include DNN, S-NSSAI in the request.

If the reporting event subscription is authorized by the UDM, the UDM records the association of the event trigger and the requester identity. Otherwise, the UDM continues in step 4 indicating failure.

If Nnef_EventExposure_Subscribe with update is received in step 1 indicating removal of event notification subscription for certain UEs in a group of UEs for which there is an event notification subscription, the NEF provides impacted UE information (e.g. SUPI, MSISDN or External Identity) with operation indication (cancellation) to UDM via Nudm_EventExposure_Subscribe without cancelling the entire group-based event notification subscription. If the Maximum Number of Reports applies to the event subscription, the NEF sets the stored number of reports of the indicated UE(s) to Maximum Number of Reports.

If Nnef_EventExposure_Subscribe with update is received in step 1 indicating addition of event notification subscription for certain UEs in a group of UEs for which there is an event notification subscription, the NEF provides impacted UE information (e.g. SUPI, MSISDN or External Identity) with operation indication (addition) to UDM via Nudm_EventExposure_Subscribe.
3a. [Conditional] If the requested event (e.g. monitoring of Loss of Connectivity) requires AMF assistance, then the UDM sends the Namf_EventExposure_Subscribe to the AMF serving the requested user. The UDM sends the Namf_EventExposure_Subscribe request to the all serving AMF(s) (if subscription applies to a UE or a group of UE(s)), or all the AMF in the same PLMN as the UDM (if subscription applies to any UE).

NOTE 1: If the UE, which is a member of a group, registers with an AMF which does not have group event subscription(s) for that group, then the UDM creates subscriptions to those event(s) with the AMF during the Registration procedure in clause 4.2.2.2.2.

As the UDM itself is not the Event Receiving NF, the UDM shall additionally provide the notification endpoint of itself besides the notification endpoint of NEF. Each notification endpoint is associated with the related (set of) Event ID(s). This is to assure the UDM can receive the notification of subscription change related event.

If the subscription applies to a group of UE(s), the UDM shall include the same notification endpoint of itself, i.e. Notification Target Address (+Notification Correlation Id), in the subscriptions to all UE's serving AMF(s).

NOTE 2: The same notification endpoint of UDM is to help the AMF identify whether the subscription for the requested group event is same or not when a new group member UE is registered.

If Nudm_EventExposure_Subscribe with update is received in step 2 indicating removal of event notification subscription for certain UEs in a group of UEs for which there is an event notification subscription, the UDM provides impacted UE information (e.g. SUPI, MSISDN) with operation indication (cancellation) to AMF via Namf_EventExposure_Subscribe without cancelling the entire group-based event notification subscription, for the event monitored by AMF.

If Nudm_EventExposure_Subscribe with update is received in step 2 indicating addition of event notification subscription for certain UEs in a group of UEs for which there is an event notification subscription, the UDM provides impacted UE information (e.g. SUPI, MSISDN) with operation indication (addition) to AMF via Namf_EventExposure_Subscribe for the event monitored by AMF.
3b. [Conditional] AMF acknowledges the execution of Namf_EventExposure_Subscribe.
3c. [Conditional] If the requested event (e.g. PDU Session Status) requires SMF assistance, then the UDM sends the Nsmf_EventExposure_Subscribe Request message to each SMF where at least one UE identified in step 2 has a PDU session established. The NEF notification endpoint received in step 2 is included in the message.

NOTE 3: In the home routed case, the UDM sends the subscription to the V-SMF via the H-SMF.
3d. [Conditional] The SMF acknowledges the execution of Nsmf_EventExposure_Subscribe.
4. [Conditional] UDM acknowledges the execution of Nudm_EventExposure_Subscribe.

If the subscription is applicable to a group of UE(s) and the Maximum number of reports is included in the Event Report information in step 1, the Number of UEs (including all group member UEs irrespective of their registration state) is included in the acknowledgement. If AMF or SMF provides the first event report in step 3b or step 3d, the UDM includes the event report in the acknowledgement.
5. NEF acknowledges the execution of Nnef_EventExposure_Subscribe to the requester that initiated the request. If the NEF has received the first event report already in step 4, the NEF includes the event report in the acknowledgement.
6a-6b. [Conditional—depending on the Event] The UDM (depending on the Event) detects the event occurs and sends the event report, by means of Nudm_EventExposure_Notify message to the associated notification endpoint of the NEF along with the time stamp. NEF may store the information in the UDR along with the time stamp using either Nudr_DM_Create or Nudr_DM_Update service operation as appropriate.

If Nudm_EventExposure_Subscribe with update is received in step 2 indicating removal of event notification subscription for certain UEs in a group of UEs for which there is an event notification subscription, the UDM shall stop the event notification for the impacted UEs. If Maximum number of Reports is applied, the UDM shall set the number of reports of the indicated UE(s) to Maximum Number of Reports for the events monitored by UDM.

If Nudm_EventExposure_Subscribe with update is received in step 2 indicating addition of event notification subscription for certain UEs in a group of UEs for which there is an event notification subscription, the UDM shall create subscription to the event notification for the impacted UEs so as to detect the monitored event and send the event report for such impacted UEs.
6c-6d. [Conditional—depending on the Event] The AMF detects the event occurs and sends the event report, by means of Namf_EventExposure_Notify message to associated notification endpoint of the NEF along with the time stamp. NEF may store the information in the UDR along with the time stamp using either Nudr_DM_Create or Nudr_DM_Update service operation as appropriate.

If the AMF has a maximum number of reports stored for the UE or the individual member UE, the AMF shall decrease its value by one for the reported event.

If Namf_EventExposure_Subscribe with update is received in step 3a indicating removal of event notification subscription for certain UEs in a group of UEs for which there is an event notification subscription, the AMF shall stop the event notification for the impacted UEs. If Maximum number of Reports is applied, the AMF shall set the number of reports of the indicated UE(s) to Maximum Number of Reports.

If Namf_EventExposure_Subscribe with update is received in step 3a indicating addition of event notification subscription for certain UEs in a group of UEs for which there is an event notification subscription, the AMF shall create subscription to the event notification for the impacted UEs so as to detect the monitored event and send the event report for such impacted UEs.

For both step 6a and step 6c, when the maximum number of reports is reached and if the subscription is applied to a UE, The NEF unsubscribes the monitoring event(s) to the UDM and the UDM unsubscribes the monitoring event(s) to AMF serving for that UE.

For both step 6a and step 6c, when the maximum number of reports is reached for an individual group member UE, the NEF uses the Number of UEs received in step 4 and the Maximum number of reports to determine if reporting for the group is complete. If the NEF determines that reporting for the group is complete, the NEF unsubscribes the monitoring event(s) to the UDM and the UDM unsubscribes the monitoring event(s) to all AMF(s) serving the UEs belonging to that group.

NOTE 4: If an expiry time as specified in clause 6.2.6.2.6 of TS 29.518 [18] is not included in the event subscription, then the life time of the event subscription needs to be controlled by other means as there is no time based cancellation at all even if any group member UEs fail to register.

When the Maximum duration of reporting expires in the NEF, the UDM and the AMF, then each of these nodes shall locally unsubscribe the monitoring event.
6e-6f. [Conditional—depending on the Event] When the SMF detects a subscribed event, the SMF sends the event report, by means of Nsmf_EventExposure_Notify message, to the associated notification endpoint of the NEF provided in step 3c. NEF may store the information in the UDR along with the time stamp using either Nudr_DM_Create or Nudr_DM_Update service operation as appropriate.
7. [Conditional—depending on the Event in steps 6a-6f] The NEF forwards to the AF the reporting event received by either Nudm_EventExposure_Notify and/or Namf_EventExposure_Notify. In the case of the PDU Session Status event, the NEF maps it to an PDN Connectivity Status notification when reporting to the AF.
8. [Conditional—depending on the Event] The AMF detects the subscription change related event occurs, e.g. Subscription Correlation ID change due to AMF reallocation or addition of new Subscription Correlation ID due to a new group UE registered, it sends the event report, by means of Namf_EventExposure_Notify message to the associated notification endpoint of the UDM.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems for the existing solution for setting up an AF session with required QoS.

The following is a solution for EES QoS scenario. For edge computing, Edge Application Server (EAS) may invoke EES QoS API to set QoS for its subscribers. The procedure is as follows.

EAS invokes EES QoS API to set QoS for a UE(GPSI(Generic Public Subscription Identifier)).

EES invokes NEF monitoring event API to subscribe PDU Session Status event.

NEF replies to EES the UE's PDU session status information, including UE allocated IP address.

EES invokes NEF QoS API to set QoS for the IP flow of the UE and the EAS in the EDN.

NEF sends Npcf_policyAuthorization_create request to PCF. After that, the PDU session between the UE and EAS gets expected QoS.

When NEF sends PDN Session Status notification to EES, the notification only includes UE allocated IP address, and doesn't include the IP domain. If overlapping private IPv4 address range is used, without the IP domain for this UE, EES is not able to provide UE's IP domain to NEF. As a result, NEF will not be able to find Binding Support Function (BSF) via Network Repository Function (NRF) because IP domain shall be included when finding BSF if overlapping private IPv4 address range is used. As a result, the QoS setup will be not be able to be completed.

To overcome or mitigate at least one above mentioned problems or other problems, an improved solution for session management may be desirable.

In a first aspect of the disclosure, there is provided a method performed by a first network node. The method may comprise receiving a first event exposure notify message from a second network node. The first event exposure notify message may comprise a user equipment (UE) Internet protocol (IP) address and an IP domain of the UE IP address.

In an embodiment, the method may further comprise sending a first event exposure subscribe request for protocol data unit (PDU) session status to the second network node. The method may further comprise receiving a first event exposure subscribe response from the second network node.

In an embodiment, the first event exposure subscribe request may comprise an indication of IP domain needed.

In an embodiment, the method may further comprise sending an application function (AF) session with quality of service (QoS) create request to the second network node. The AF session with QoS create request may comprise the UE IP address, the IP domain of the UE IP address, and an application function IP address.

In an embodiment, the first network node may comprise at least one of an application function (AF), or an edge enabler server (EES).

In an embodiment, the second network node may comprise a network exposure function.

In an embodiment, the UE IP address may comprise an IP private address.

In an embodiment, a same IP address can be allocated to two or more PDU sessions in different IP address domains.

In a second aspect of the disclosure, there is provided a method performed by a second network node. The method may comprise receiving a second event exposure notify message from a third network node. The method may further comprise sending a first event exposure notify message to a first network node. The second event exposure notify message may comprise a user equipment (UE) Internet protocol (IP) address and an IP domain of the UE IP address. The first event exposure notify message may comprise the UE IP address and the IP domain of the UE IP address.

In an embodiment, the method may further comprise receiving a first event exposure subscribe request for protocol data unit (PDU) session status from the first network node. The method may further comprise sending a second event exposure subscribe request for the PDU session status to a fourth network node. The method may further comprise receiving a second event exposure subscribe response from the fourth network node. The method may further comprise sending a first event exposure subscribe response to the first network node.

In an embodiment, the first event exposure subscribe request may comprise an indication of IP domain needed and/or the second event exposure subscribe request may comprise an indication of IP domain needed.

In an embodiment, the method may further comprise receiving an application function (AF) session with quality of service (QoS) create request from the first network node. The method may further comprise sending a policy authorization create request to a policy control function. The AF session with QoS create request may comprise the UE IP address, the IP domain of the UE IP address, and an application function IP address. The policy authorization create request may comprise the UE IP address, the IP domain of the UE IP address, and an application function IP address.

In an embodiment, the first network node may comprise at least one of an application function (AF), or an edge enabler server (EES).

In an embodiment, the second network node may comprise a network exposure function.

In an embodiment, the third network node may comprise a session management function.

In an embodiment, the fourth network node may comprise a unified data management (UDM).

In an embodiment, the UE IP address may comprise an IP private address.

In an embodiment, a same IP address can be allocated to two or more PDU sessions in different IP address domains.

In a third aspect of the disclosure, there is provided a method performed by a fourth network node. The method may comprise receiving a second event exposure subscribe request for the PDU session status from a second network node. The method may further comprise sending a second event exposure subscribe response to the second network node. The second event exposure subscribe request may comprise an indication of IP domain needed.

In an embodiment, the method may further comprise sending a third event exposure subscribe request for the PDU session status to a third network node. The method may further comprise receiving third event exposure subscribe response from the third network node. The third event exposure subscribe request may comprise an indication of IP domain needed.

In an embodiment, the third network node may comprise a session management function.

In an embodiment, the second network node may comprise a network exposure function.

In an embodiment, the fourth network node may comprise a unified data management (UDM).

In a fourth aspect of the disclosure, there is provided a method performed by a third network node. The method may comprise sending a second event exposure notify message to a second network node. The second event exposure notify message may comprise a user equipment (UE) Internet protocol (IP) address and an IP domain of the UE IP address.

In an embodiment, the method may further comprise receiving a third event exposure subscribe request for protocol data unit (PDU) session status from a fourth network node. The method may further comprise sending a third event exposure subscribe response to the fourth network node.

In an embodiment, the fourth network node may comprise a unified data management (UDM).

In an embodiment, the third event exposure subscribe request may comprise an indication of IP domain needed.

In an embodiment, the second network node may comprise a network exposure function.

In an embodiment, the third network node may comprise a session management function.

In an embodiment, the UE IP address may comprise an IP private address.

In an embodiment, a same IP address can be allocated to two or more PDU sessions in different IP address domains.

In a fifth aspect of the disclosure, there is provided a first network node. The first network node may comprise a processor and a memory coupled to the processor. Said memory contains instructions executable by said processor. The first network node is operative to receive a first event exposure notify message from a second network node. The first event exposure notify message may comprise a user equipment (UE) Internet protocol (IP) address and an IP domain of the UE IP address.

In an sixth aspect of the disclosure, there is provided a second network node. The second network node may comprise a processor and a memory coupled to the processor. Said memory contains instructions executable by said processor. The second network node is operative to receive a second event exposure notify message from a third network node. The second network node is further operative to send a first event exposure notify message to a first network node. The second event exposure notify message may comprise a user equipment (UE) Internet protocol (IP) address and an IP domain of the UE IP address. The first event exposure notify message may comprise the UE IP address and the IP domain of the UE IP address.

In a seventh aspect of the disclosure, there is provided a fourth network node. The fourth network node may comprise a processor and a memory coupled to the processor. Said memory contains instructions executable by said processor. The fourth network node is operative to receive a second event exposure subscribe request for the PDU session status from a second network node. The fourth network node is further operative to send a second event exposure subscribe response to the second network node. The second event exposure subscribe request may comprise an indication of IP domain needed

In an eighth aspect of the disclosure, there is provided a third network node. The third network node may comprise a processor and a memory coupled to the processor. Said memory contains instructions executable by said processor. The third network node is operative to send a second event exposure notify message to a second network node. The second event exposure notify message may comprise a user equipment (UE) Internet protocol (IP) address and an IP domain of the UE IP address.

In another aspect of the disclosure, there is provided a first network node. The first network node may comprise a first receiving module configured to receive a first event exposure notify message from a second network node. The first event exposure notify message may comprise a user equipment (UE) Internet protocol (IP) address and an IP domain of the UE IP address.

In an embodiment, the first network node may further comprise a first sending module configured to send a first event exposure subscribe request for protocol data unit (PDU) session status to the second network node.

In an embodiment, the first network node may further comprise a second receiving module configured to receive a first event exposure subscribe response from the second network node.

In an embodiment, the first network node may further comprise a second sending module configured to send an application function (AF) session with quality of service (QoS) create request to the second network node. The AF session with QoS create request may comprise the UE IP address, the IP domain of the UE IP address, and an application function IP address.

In another aspect of the disclosure, there is provided a second network node. The second network node may comprise a first receiving module configured to receive a second event exposure notify message from a third network node. The second network node may further comprise a first sending module configured to send a first event exposure notify message to a first network node. The second event exposure notify message may comprise a user equipment (UE) Internet protocol (IP) address and an IP domain of the UE IP address. The first event exposure notify message may comprise the UE IP address and the IP domain of the UE IP address.

In an embodiment, the second network node may further comprise a second receiving module configured to receive a first event exposure subscribe request for protocol data unit (PDU) session status from the first network node.

In an embodiment, the second network node may further comprise a second sending module configured to send a second event exposure subscribe request for the PDU session status to a fourth network node.

In an embodiment, the second network node may further comprise a third receiving module configured to receive a second event exposure subscribe response from the fourth network node.

In an embodiment, the second network node may further comprise a third sending module configured to send a first event exposure subscribe response to the first network node.

In an embodiment, the second network node may further comprise a fourth receiving module configured to receive an application function (AF) session with quality of service (QoS) create request from the first network node. The AF session with QoS create request may comprise the UE IP address, the IP domain of the UE IP address, and an application function IP address.

In an embodiment, the second network node may further comprise a fourth sending module configured to send a policy authorization create request to a policy control function. The policy authorization create request may comprise the UE IP address, the IP domain of the UE IP address, and an application function IP address.

In another aspect of the disclosure, there is provided a fourth network node. The fourth network node may comprise a first receiving module configured to receive a second event exposure subscribe request for the PDU session status from a second network node. The fourth network node may further comprise a first sending module configured to send a second event exposure subscribe response to the second network node. The second event exposure subscribe request may comprise an indication of IP domain needed.

In an embodiment, the fourth network node may further comprise a second sending module configured to send a third event exposure subscribe request for the PDU session status to a third network node. The third event exposure subscribe request may comprise an indication of IP domain needed.

In an embodiment, the fourth network node may further comprise a second receiving module configured to receive third event exposure subscribe response from the third network node. The third event exposure subscribe request may comprise an indication of IP domain needed.

In another aspect of the disclosure, there is provided a third network node. The third network node may comprise a first sending module configured to send a second event exposure notify message to a second network node. The second event exposure notify message may comprise a user equipment (UE) Internet protocol (IP) address and an IP domain of the UE IP address.

In an embodiment, the third network node may further comprise a receiving module configured to receive a third event exposure subscribe request for protocol data unit (PDU) session status from a fourth network node.

In an embodiment, the third network node may further comprise a second sending module configured to send a third event exposure subscribe response to the fourth network node.

In another aspect of the disclosure, there is provided a computer program product comprising instructions which when executed by at least one processor, cause the at least one processor to perform the method according to any one of the first, second, third, or fourth aspects.

In another aspect of the disclosure, there is provided a computer-readable storage medium storing instructions which when executed by at least one processor, cause the at least one processor to perform the method according to any one of the first, second, third, or fourth aspects.

Embodiments herein may provide many advantages, of which a non-exhaustive list of examples follows. In some embodiments herein, it can support to apply the required QoS when overlapping private address range is used. In some embodiments herein, it may improve the NEF Event Exposure capability to include an indication of IP_domain_needed for PDU session status event. IP domain is necessary for NEF to apply the required QoS for an IP flow when overlapping private address range is used. In some embodiments herein, it may enhance 3GPP procedure to instruct SMF to include the IP domain of UE IP address, which is essential for NEF to be able to complete SessionWithQOS API operation. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a shows a reference point representation of architecture for edge enabling applications according to an embodiment of the present disclosure;

FIG. 1b shows a flowchart of the session with QoS create operation between the EAS and the EES;

FIG. 1c shows a flowchart of Nnef_EventExposure_Subscribe, Unsubscribe and Notify operations;

FIG. 2a schematically shows a high level architecture in the fifth generation network according to an embodiment of the present disclosure;

FIG. 2 b schematically shows system architecture in a 4G network according to an embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 4c shows a flowchart of a method according to another embodiment of the present disclosure;

FIG. 5a shows a flowchart of a method according to another embodiment of the present disclosure;

FIG. 5b shows a flowchart of a method according to another embodiment of the present disclosure;

FIG. 6a shows a flowchart of a method according to another embodiment of the present disclosure;

FIG. 6b shows a flowchart of a method according to another embodiment of the present disclosure;

FIG. 7a shows a flowchart of call flow without IP domain;

FIG. 7b shows a flowchart of call flow with IP domain according to an embodiment of the present disclosure;

FIG. 8a is a block diagram showing an apparatus suitable for practicing some embodiments of the disclosure;

FIG. 8b is a block diagram showing a first network node according to an embodiment of the disclosure;

FIG. 8c is a block diagram showing a second network node according to an embodiment of the disclosure;

FIG. 8d is a block diagram showing a fourth network node according to another embodiment of the disclosure;

FIG. 9 is a block diagram showing a third network node according to another embodiment of the disclosure;

FIG. 10 shows an example of a communication system according to an embodiment of the disclosure;

FIG. 11 is a block diagram of a host according to an embodiment of the disclosure; and

FIG. 12 shows a communication diagram of a host communicating via a network node with a UE over a partially wireless connection according to an embodiment of the disclosure.

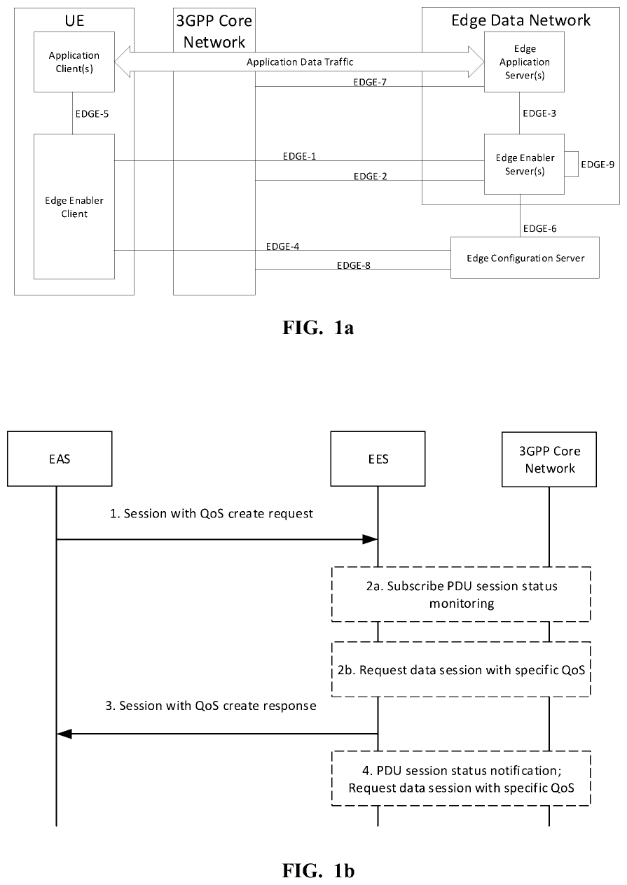

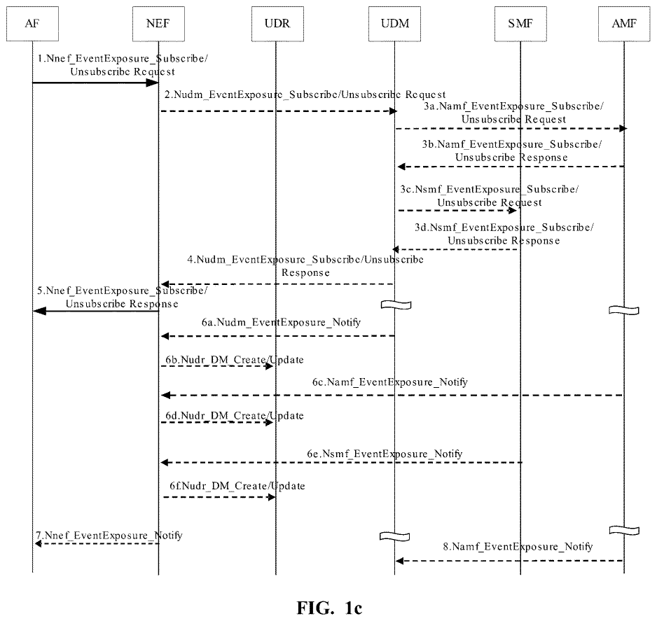

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network node” or “network node” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “may comprise”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

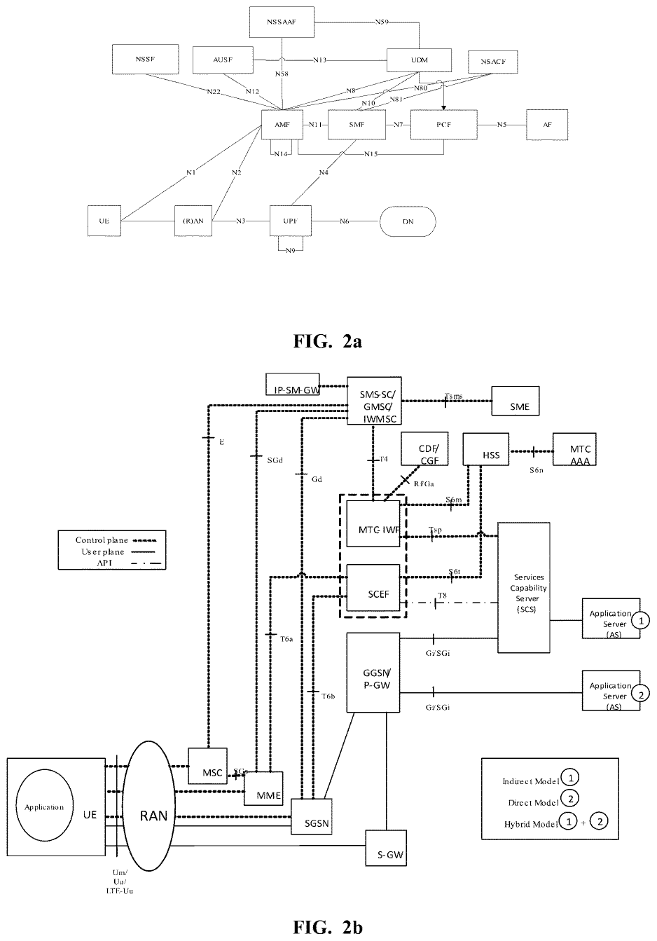

Although the subject matter described herein may be implemented in any appropriate type of system using any suitable components, the embodiments disclosed herein are described in relation to a communication system complied with the exemplary system architectures illustrated in FIGS. 2a-2b. For simplicity, the system architectures of FIGS. 2a-2b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

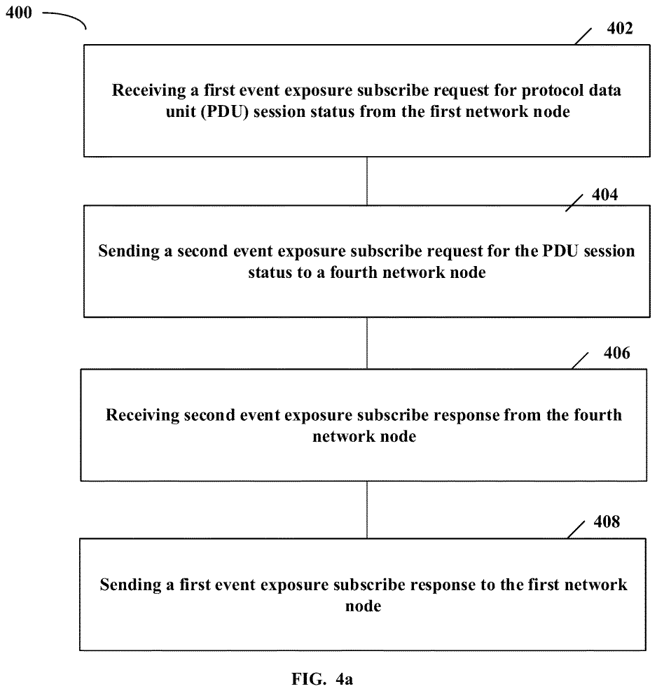

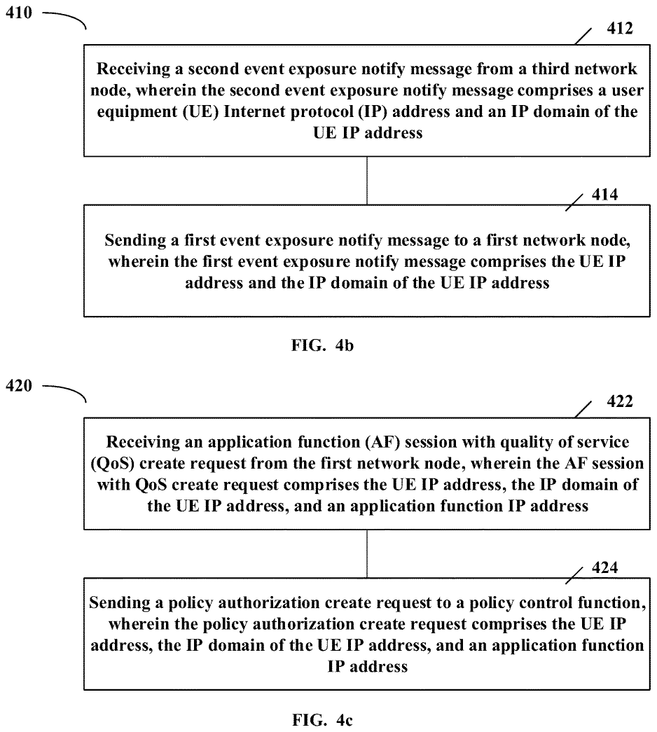

FIG. 2a schematically shows a high level architecture in the fifth generation network according to an embodiment of the present disclosure. For example, the fifth generation network may be 5GS. The architecture of FIG. 2a is same as FIG. 4.2.3-2 as described in 3GPP TS 23.501 V17.2.0, the disclosure of which is incorporated by reference herein in its entirety. The system architecture of FIG. 2a may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2a, the exemplary system architecture also contains some reference points such as N1, N2, N3, N4, N6, N9, N15, etc., which can support the interactions between NF services in the NFs. For example, these reference points may be realized through corresponding NF service-based interfaces and by specifying some NF service consumers and providers as well as their interactions in order to perform a particular system procedure. The AM related policy is provided by PCF to AMF for a registered UE via N15 interface. AMF can get AM policy during AM Policy Association Establishment/Modification procedure.

Various NFs shown in FIG. 2a may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.2.0.

FIG. 2b schematically shows system architecture in a 4G network according to an embodiment of the present disclosure, which is the same as FIG. 4.2-1a of 3GPP TS 23.682 V17.2.0, the disclosure of which is incorporated by reference herein in its entirety. The system architecture of FIG. 2b may comprise some exemplary elements such as Services Capability Server (SCS), Application Server (AS), SCEF (Service Capability Exposure Function), HSS, UE, RAN(Radio Access Network), SGSN (Serving GPRS(General Packet Radio Service) Support Node), MME, MSC(Mobile Switching Centre), S-GW(Serving Gateway), GGSN/P-GW(Gateway GPRS Support Node/PDN(Packet Data Network) Gateway), MTC-IWF(Machine Type Communications-InterWorking Function) CDF/CGF(Charging Data Function/Charging Gateway Function), MTC-AAA(Machine Type Communications-authentication, authorization and accounting), SMS-SC/GMSC/IWMSC(Short Message Service-Service Centre/Gateway MSC/InterWorking MSC) IP-SM-GW(Internet protocol Short Message Gateway). The network elements and interfaces as shown in FIG. 2b may be same as the corresponding network elements and interfaces as described in 3GPP TS 23.682 V17.2.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 2b, the exemplary system architecture also contains various reference points.

Tsms: Reference point used by an entity outside the 3GPP network to communicate with UEs used for MTC via SMS (Short Message Service).

Tsp: Reference point used by a SCS to communicate with the MTC-IWF related control plane signalling.

T4: Reference point used between MTC-IWF and the SMS-SC in the HPLMN.

T6a: Reference point used between SCEF and serving MME.

T6b: Reference point used between SCEF and serving SGSN.

T8: Reference point used between the SCEF and the SCS/AS.

S6m: Reference point used by MTC-IWF to interrogate HSS/HLR (Home Location Register).

S6n: Reference point used by MTC-AAA to interrogate HSS/HLR.

S6t: Reference point used between SCEF and HSS.

SGs: Reference point used between MSC and MME.

Gi/SGi: Reference point used between GGSN/P-GW and application server and between GGSN/P-GW and SCS.

Rf/Ga: Reference point used between MTC-IWF and CDF/CGF.

Gd: Reference point used between SMS-SC/GMSC/IWMSC and SGSN.

SGd: Reference point used between SMS-SC/GMSC/IWMSC and MME.

E: Reference point used between SMS-SC/GMSC/IWMSC and MSC.

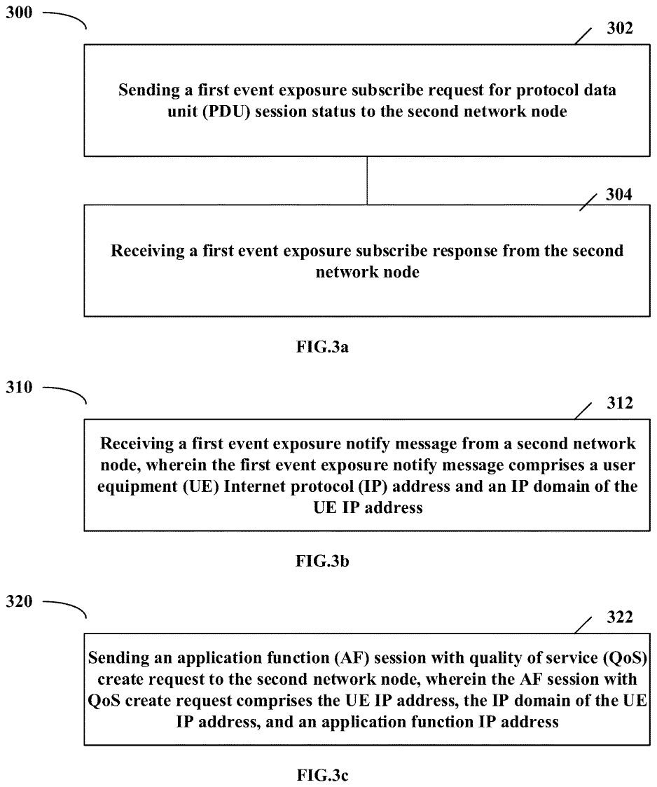

FIG. 3a shows a flowchart of a method according to an embodiment of the present disclosure, which may be performed by an apparatus implemented in or at or as a first network node or communicatively coupled to the first network node. As such, the apparatus may provide means or modules for accomplishing various parts of the method 300 as well as means or modules for accomplishing other processes in conjunction with other components.

At block 302, the first network node may send a first event exposure subscribe request for protocol data unit (PDU) session status to a second network node.

The first network node may be any suitable node such as core network node of 3GPP network. For example, the first network node may provide similar or same function as the AF as described in 3GPP TS 23.501 V17.5.0 or the Application Server (AS) or Services Capability Server (SCS) as described in 3GPP TS 23.682 V17.2.0 or Edge Enabler Server (EES) as described in 3GPP TS 23.558 V17.4.0.

In an embodiment, the first network node may comprise at least one of an application function (AF) or an edge enabler server (EES).

The second network node may be any suitable node such as core network node of 3GPP network. For example, the second network node may provide similar or same function as the NEF as described in 3GPP TS 23.501 V17.5.0 or the SCEF as described in 3GPP TS 23.682 V17.2.0 or a combined NEF and SCEF.

In an embodiment, the second network node may comprise a network exposure function such as NEF, SCEF or a combined NEF and SCEF.

In an embodiment, the first event exposure subscribe request may be Nnef_EventExposure_Subscribe request as described in 3GPP TS 23.502 V17.5.0.

In an embodiment, the first event exposure subscribe request may comprise an indication of IP domain needed. The indication may be any suitable information such as a bit, a flag, an indicator, etc.

The first network node may send the first event exposure subscribe request to the second network node due to various reasons. For example, when the first network node needs to know a user equipment (UE) Internet protocol (IP) address and an IP domain of the UE IP address, it may send the first event exposure subscribe request to the second network node.

At block 304, the first network node may receive a first event exposure subscribe response from the second network node.

In an embodiment, the first event exposure subscribe response may be Nnef_EventExposure_Subscribe response as described in 3GPP TS 23.502 V17.5.0.

FIG. 3b shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, the first network node may receive a first event exposure notify message from the second network node. The first event exposure notify message may comprise a user equipment (UE) Internet protocol (IP) address and an IP domain of the UE IP address.

For example, the first event exposure notify message may be Nnef_EventExposure_Notify as described in 3GPP TS 23.502 V17.5.0.

In an embodiment, after sending the first event exposure subscribe request, the first network node may receive a first event exposure notify message from the second network node.

In an embodiment, the UE IP address may comprise an IP private address.

In an embodiment, a same IP address can be allocated to two or more PDU sessions in different IP address domains.

In an embodiment, the first network node may send a message to an EAS. The message may comprise a user equipment (UE) Internet protocol (IP) address and an IP domain of the UE IP address. In this way, when the EAS requests establishment of a data session between the AC and the EAS with a specific QoS, it may send a session with QoS create request as described in clause 8.6.6.2.2 of 3GPP TS 23.558 V17.4.0 to EES and the session with QoS create request may comprise the user equipment (UE) Internet protocol (IP) address and an IP domain of the UE IP address.

FIG. 3c shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 320 as well as means or modules for accomplishing other processes in conjunction with other components. For some parts which have been described in the above embodiments, the description thereof is omitted here for brevity.

At block 322, the first network node may send an application function (AF) session with quality of service (QoS) create request to the second network node.

In an embodiment, the AF session with QoS create request may comprise the UE IP address, the IP domain of the UE IP address, and an application function IP address.

In an embodiment, the AF session with QoS create request may be same as Nnef_AFsessionWithQoS_Create request message as described in 3GPP TS 23.502 V17.5.0.

In an embodiment, with the IP domain for a UE, the first network node be able to find BSF via NRF because IP domain is included when finding BSF if overlapping private IPv4 address range is used. As a result, the QoS setup will be able to be completed.

In an embodiment, the first network node may invoke the Policy Authorization Create service or the AF Session with QoS service with the 3GPP Core Network (PCF or NEF, respectively) as described in 3GPP TS 23.501 V17.5.0 and 3GPP TS 23.502 V17.5.0, providing the specific QoS (QoS reference or bandwidth) to the PCF as described in 3GPP TS 23.503 V17.5.0 , clause 6.1.3.22.

FIG. 4a shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the second network node may receive a first event exposure subscribe request for protocol data unit (PDU) session status from the first network node. For example, the first network node may send the first event exposure subscribe request to the second network node at block 302 of FIG. 3a, then the second network node may receive the first event exposure subscribe request from the first network node.

In an embodiment, the first event exposure subscribe request may comprise an indication of IP domain needed may comprise an indication of IP domain needed.

In an embodiment, the first network node may comprise at least one of an application function (AF) or an edge enabler server (EES).

In an embodiment, the second network node may comprise a network exposure function such as NEF or SCEF or a combined NEF and SCEF.

At block 404, the second network node may send a second event exposure subscribe request for the PDU session status to a fourth network node.

The fourth network node may be any suitable node such as core network node of 3GPP network. In an embodiment, the fourth network node may comprise a unified data management (UDM). In an embodiment, the fourth network node may comprise HSS. In an embodiment, the fourth network node may comprise MME/SGSN. In an embodiment, the fourth network node may comprise SMF.

In an embodiment, the second event exposure subscribe request may comprise an indication of IP domain needed.

In an embodiment, the second event exposure subscribe request may be Nudm_EventExposure_Subscribe Request as described in 3GPP TS 23.502 V17.5.0.

At block 406, the second network node may receive a second event exposure subscribe response from the fourth network node.

In an embodiment, the second event exposure subscribe response may be Nudm_EventExposure_Subscribe Response as described in 3GPP TS 23.502 V17.5.0.

At block 408, the second network node may send a first event exposure subscribe response to the first network node.

FIG. 4b shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, the second network node may receive a second event exposure notify message from a third network node.

In an embodiment, the second event exposure notify message may comprise a user equipment (UE) Internet protocol (IP) address and an IP domain of the UE IP address.

The third network node may be any suitable node such as core network node of 3GPP network. In an embodiment, the third network node may comprise a session management function (SMF). In another embodiment, the third network node may comprise UDM. In another embodiment, the third network node may comprise HSS. In another embodiment, the third network node may comprise MME/SGSN.

In an embodiment, the second event exposure notify message Nudm_EventExposure_Notify or Nsmf_EventExposure_Notify as described in 3GPP TS 23.502 V17.5.0.

At block 414, the second network node may send a first event exposure notify message to a first network node.

In an embodiment, the first event exposure notify message may comprise the UE IP address and the IP domain of the UE IP address.

In an embodiment, the UE IP address may comprise an IP private address.

In an embodiment, a same IP address can be allocated to two or more PDU sessions in different IP address domains.

FIG. 4c shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 420 as well as means or modules for accomplishing other processes in conjunction with other components. For some parts which have been described in the above embodiments, the description thereof is omitted here for brevity.

At block 422, the second network node may receive an application function (AF) session with quality of service (QoS) create request from the first network node.

In an embodiment, the AF session with QoS create request may comprise the UE IP address, the IP domain of the UE IP address, and an application function IP address.

At block 424, the second network node may send a policy authorization create request to a policy control function.

In an embodiment, the policy authorization create request may comprise the UE IP address, the IP domain of the UE IP address, and an application function IP address.

In an embodiment, the policy control function may be PCF as described in 3GPP TS 23.502 V17.5.0.

For example, when NEF sends PDN Session Status notification to EES, the notification may include UE allocated IP address and the IP domain. If overlapping private IPv4 address range is used, with the IP domain for this UE, EES is able to provide UE's IP domain to NEF. As a result, NEF will be able to find BSF via NRF because IP domain is included when finding BSF if overlapping private IPv4 address range is used. As a result, the QoS setup will be able to be completed.

In an embodiment, the policy authorization create request may be same as the Npcf_PolicyAuthorization_Create request as described in 3GPP TS 23.502 V17.5.0.

In an embodiment, the second network node such as NEF may use the Setting up an AF session with required QoS procedure as described in clause 4.15.6.6 of 3GPP TS 23.502 V17.5.0.

In an embodiment, the second network node such as NEF may use the Session with QoS API create operation as described in clause 8.6.6.2.2 of 3GPP TS 23.558 V17.4.0.

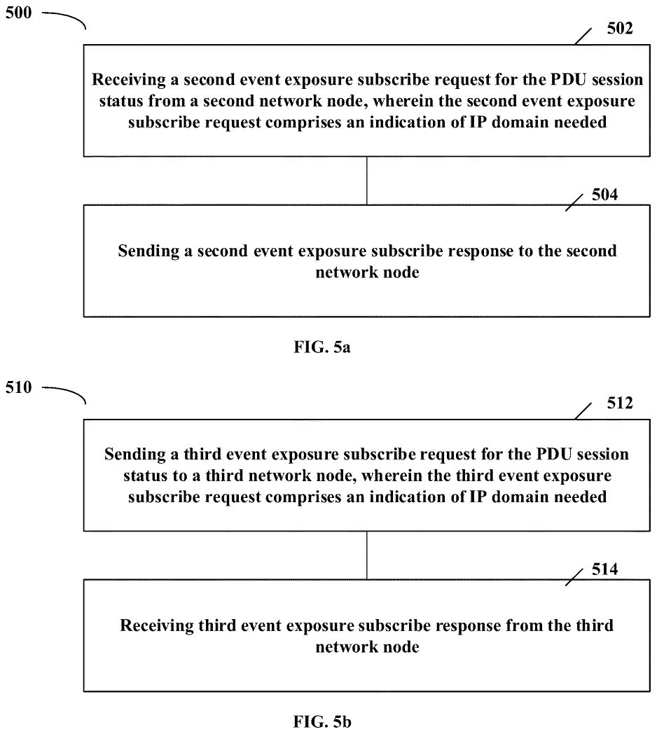

FIG. 5a shows a flowchart of a method according to another embodiment of the present disclosure, which may be performed by an apparatus implemented in or at or as a fourth network node or communicatively coupled to the fourth network node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the fourth network node may receive a second event exposure subscribe request for the PDU session status from a second network node.

In an embodiment, the second network node may comprise a network exposure function.

The fourth network node may be any suitable node such as core network node of 3GPP network. In an embodiment, the fourth network node may comprise a unified data management (UDM). In an embodiment, the fourth network node may comprise HSS. In an embodiment, the fourth network node may comprise MME/SGSN. In an embodiment, the fourth network node may comprise SMF.

In an embodiment, the second event exposure subscribe request may comprise an indication of IP domain needed.

At block 504, the fourth network node may send a second event exposure subscribe response to the second network node.

In an embodiment, the second event exposure subscribe request may comprise an indication of IP domain needed.

FIG. 5b shows a flowchart of a method according to another embodiment of the present disclosure, which may be performed by an apparatus implemented in or at or as a fourth network node or communicatively coupled to the fourth network node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 512, the fourth network node may send a third event exposure subscribe request for the PDU session status to a third network node.

The third network node may be any suitable node such as core network node of 3GPP network. In an embodiment, the third network node may comprise a session management function (SMF). In another embodiment, the third network node may comprise UDM. In another embodiment, the third network node may comprise HSS. In another embodiment, the third network node may comprise MME/SGSN.

In an embodiment, the third event exposure subscribe request may comprise an indication of IP domain needed.

At block 514, the fourth network node may receive third event exposure subscribe response from the third network node.

In an embodiment, the third event exposure subscribe request may comprise an indication of IP domain needed.

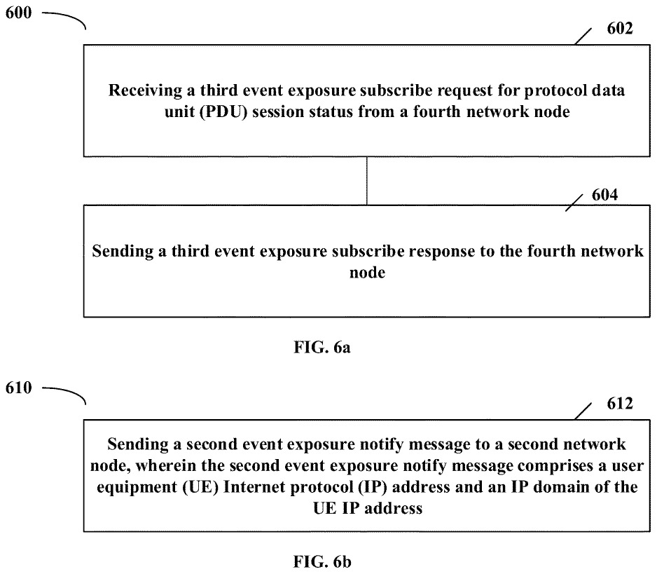

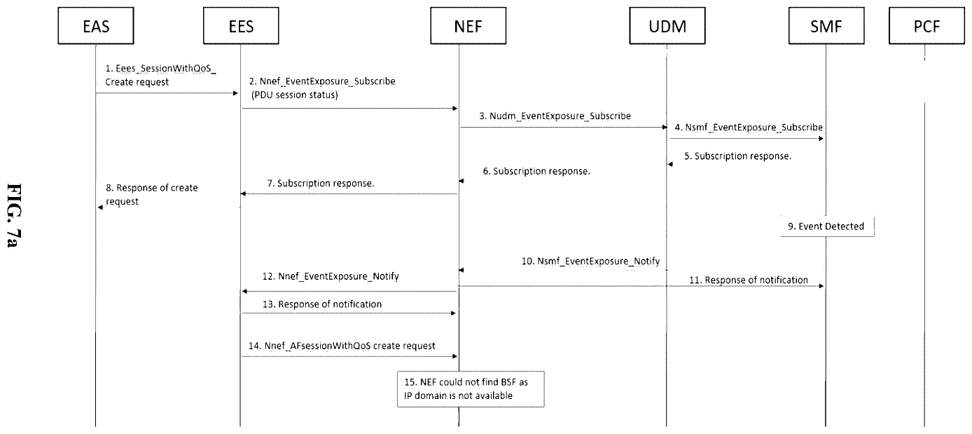

FIG. 6a shows a flowchart of a method according to another embodiment of the present disclosure, which may be performed by an apparatus implemented in or at or as a third network node or communicatively coupled to the third network node. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the third network node may receive a third event exposure subscribe request for protocol data unit (PDU) session status from a fourth network node.

The third network node may be any suitable node such as core network node of 3GPP network. In an embodiment, the third network node may comprise a session management function (SMF). In another embodiment, the third network node may comprise MME/SGSN.

The fourth network node may be any suitable node such as core network node of 3GPP network. In an embodiment, the fourth network node may comprise a unified data management (UDM). In an embodiment, the fourth network node may comprise HSS.

At block 604, the third network node may sends a third event exposure subscribe response to the fourth network node.

In an embodiment, the third event exposure subscribe request may comprise an indication of IP domain needed.

FIG. 6b shows a flowchart of a method according to another embodiment of the present disclosure, which may be performed by an apparatus implemented in or at or as a third network node or communicatively coupled to the third network node. As such, the apparatus may provide means or modules for accomplishing various parts of the method 610 as well as means or modules for accomplishing other processes in conjunction with other components. For some parts which have been described in the above embodiments, the description thereof is omitted here for brevity.

At block 612, the third network node may send a second event exposure notify message to a second network node.

In an embodiment, the second event exposure notify message may comprise a user equipment (UE) Internet protocol (IP) address and an IP domain of the UE IP address.

In an embodiment, the second network node may comprise a network exposure function.

In an embodiment, the UE IP address may comprise an IP private address.

In an embodiment, a same IP address can be allocated to two or more PDU sessions in different IP address domains.

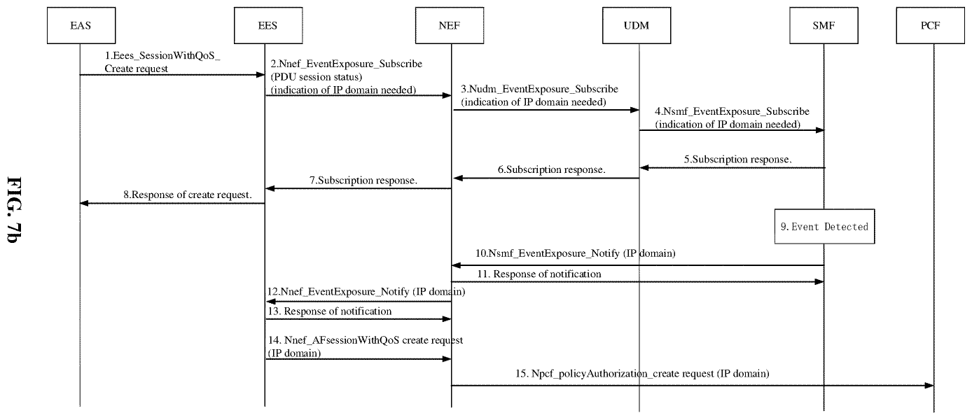

FIG. 7a shows a flowchart of call flow without IP domain.
At step 1. The EAS requests establishment of a data session between the AC and the EAS with a specific QoS (either QoS reference or bandwidth) for a GPSI. The EAS sends an Eees_SessionwithQoS_Create request to EES.
At step 2. The EES checks if the EAS is authorized for this operation for the UE. If authorized, then the EES invokes the Event Monitoring service for PDU session status with the 3GPP Core Network, as described in 3GPP TS 23.502 V17.5.0. The EES sends an Nnef_EventExposure_Subscribe request (PDU session status) to NEF.
At step 3. The NEF invokes Nudm_EventExposure_subscribe operation towards UDM. The request includes UE's GPSI.
At step 4. UDM invokes Nsmf_EventExposure_Subscribe operation towards SMF.
At step 5. SMF sends a subscription response to UDM.
At step 6. UDM sends a subscription response to NEF.
At step 7. NEF sends a subscription response to EES.
At step 8. EES sends a response of create request to EAS.
At step 9. SMF detects the UE has established a new PDU session.
At step 10. SMF uses Nsmf_EventExposure_Notify operation to notify NEF the UE's PDU session status. The notification includes the UE allocated IP address.
At step 11. NEF sends a notification response to SMF.
At step 12. NEF uses Nnef_EventExposure_Notify operation to notify EES the UE's PDU session status. The notification includes the UE allocated IP address and doesn't include the IP domain.
At step 13. EES sends a notification response to NEF.
At step 14. EES uses Nnef_AFsessionWithQoS_create request to set QoS for the UE's IP flow. The request includes UE allocated IP address and EAS IP address. EES is not able to provide UE's IP domain to NEF.
At step 15. As a result, NEF will not be able to find BSF via NRF because IP domain is not included when finding BSF if overlapping private IPv4 address range is used. As a result, the QoS setup will be not be able to be completed.

Some messages of FIG. 7a may be same as the corresponding message as described in various 3GPP specifications such as 3GPP TS 23.558 V17.4.0 or 3GPP TS 23.502 V17.2.0.

FIG. 7b shows a flowchart of call flow with IP domain according to an embodiment of the present disclosure.
At step 1. The EAS requests establishment of a data session between the AC and the EAS with a specific QoS (either QoS reference or bandwidth) for a GPSI. The EAS sends an Eees_SessionwithQoS_Create request to EES.
At step 2. The EES checks if the EAS is authorized for this operation for the UE. If authorized, then the EES invokes the Event Monitoring service for PDU session status with the 3GPP Core Network, as described in 3GPP TS 23.502 V17.5.0. The EES sends an Nnef_EventExposure_Subscribe request (PDU session status) to NEF.
At step 3. The NEF invokes Nudm_EventExposure_subscribe operation towards UDM. The request includes UE's GPSI, and an indication of IP_domain_needed.
At step 4. UDM invokes Nsmf_EventExposure_Subscribe operation towards SMF. The request includes an indication of IP_domain_needed.
At step 5. SMF sends a subscription response to UDM.
At step 6. UDM sends a subscription response to NEF.
At step 7. NEF sends a subscription response to EES.
At step 8. EES sends a response of create request to EAS.
At step 9. SMF detects the UE has established a new PDU session.
At step 10. SMF uses Nsmf_EventExposure_Notify operation to notify NEF the UE's PDU session status. The notification includes the UE allocated IP address and IP domain of the UE IP address.
At step 11. NEF sends a notification response to SMF.
At step 12. NEF uses Nnef_EventExposure_Notify operation to notify EES the UE's PDU session status. The notification includes the UE allocated IP address and the IP domain of the UE IP address.
At step 13. EES sends a notification response to NEF.
At step 14. EES uses Nnef_AFsessionWithQoS_create request to set QoS for the UE's IP flow. The request includes UE allocated IP address, IP domain of the UE IP address, EAS IP address.
At step 15. NEF will be able to find BSF via NRF because IP domain is included when finding BSF if overlapping private IPv4 address range is used. NEF uses Npcf_policyAuthorization_create request to set QoS for the UE's IP flow. The request includes UE allocated IP address, IP domain of the UE IP address, EAS IP address. As a result, the QoS setup will be able to be completed.

Some messages of FIG. 7b may be same as the corresponding message as described in various 3GPP specifications such as 3GPP TS 23.558 V17.4.0 or 3GPP TS 23.502 V17.2.0. Some messages of FIG. 7b may be enhanced according to various embodiments of the present disclosure.

According to various embodiments, it may add a new parameter “Indication_IP_domain_needed” in NEF Event Exposure API.

Embodiments herein may provide many advantages, of which a non-exhaustive list of examples follows. In some embodiments herein, it can support to apply the required QoS when overlapping private address range is used. In some embodiments herein, it may improve the NEF Event Exposure capability to include an indication of IP_domain_needed for PDU session status event. IP domain is necessary for NEF to apply the required QoS for an IP flow when overlapping private address range is used. In some embodiments herein, it may enhance 3GPP procedure to instruct SMF to include the IP domain of UE IP address, which is essential for NEF to be able to complete SessionWithQOS API operation. The embodiments herein are not limited to the features and advantages mentioned above. A person skilled in the art will recognize additional features and advantages upon reading the following detailed description.

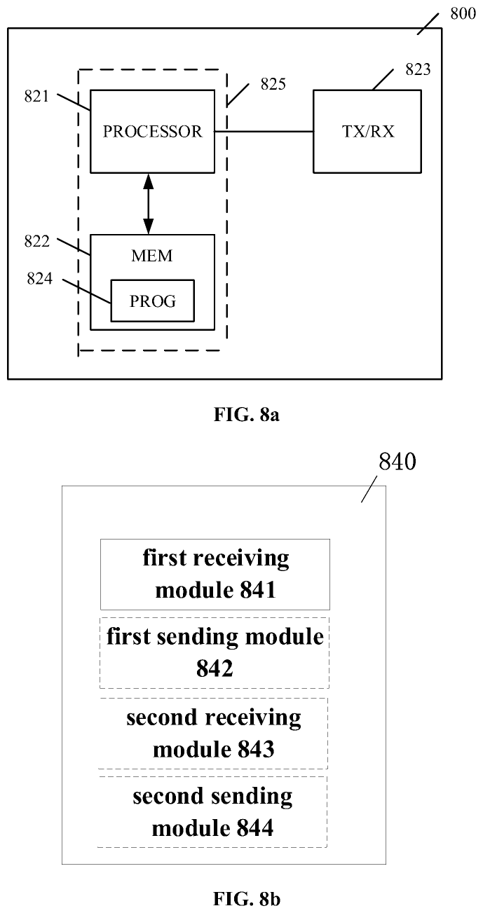

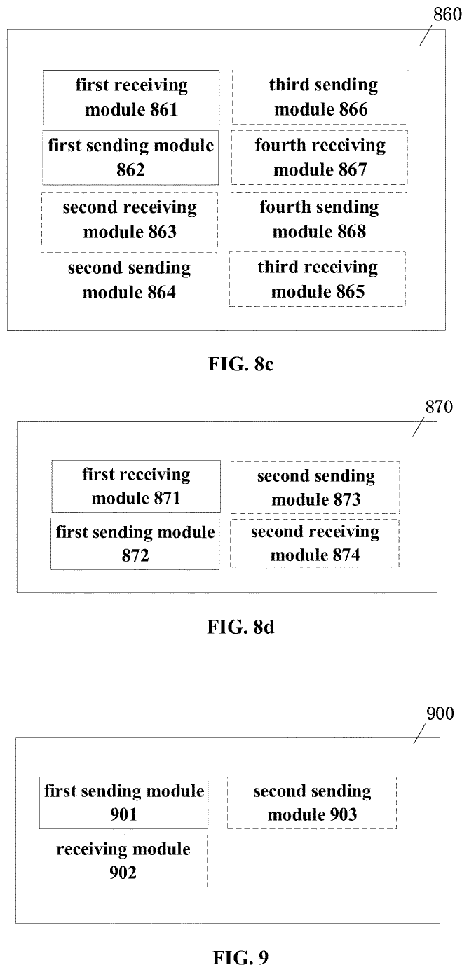

FIG. 8a is a block diagram showing an apparatus suitable for practicing some embodiments of the disclosure. For example, any one of the first network node, the second network node, the third network node, or the fourth network node described above may be implemented as or through the apparatus 800.

The apparatus 800 may comprise at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first network node, the memory 822 contains instructions executable by the processor 821, whereby the first network node operates according to any of the methods related to the first network node as described above.

In an embodiment where the apparatus is implemented as or at the second network node, the memory 822 contains instructions executable by the processor 821, whereby the second network node operates according to any of the methods related to the second network node as described above.

In an embodiment where the apparatus is implemented as or at the third network node, the memory 822 contains instructions executable by the processor 821, whereby the third network node operates according to any of the methods related to the third network node as described above.

In an embodiment where the apparatus is implemented as or at the fourth network node, the memory 822 contains instructions executable by the processor 821, whereby the fourth network node operates according to any of the methods related to the fourth network node as described above.

FIG. 8b is a block diagram showing a first network node according to an embodiment of the disclosure. As shown, the first network node 840 may comprise a first receiving module 841 configured to receive a first event exposure notify message from a second network node. The first event exposure notify message may comprise a user equipment (UE) Internet protocol (IP) address and an IP domain of the UE IP address.

In an embodiment, the first network node 840 may further comprise a first sending module 842 configured to send a first event exposure subscribe request for protocol data unit (PDU) session status to the second network node.

In an embodiment, the first network node 840 may further comprise a second receiving module 843 configured to receive a first event exposure subscribe response from the second network node.

In an embodiment, the first network node 840 may further comprise a second sending module 844 configured to send an application function (AF) session with quality of service (QoS) create request to the second network node. The AF session with QoS create request may comprise the UE IP address, the IP domain of the UE IP address, and an application function IP address.

FIG. 8c is a block diagram showing a second network node according to an embodiment of the disclosure. As shown, the second network node 860 may comprise a first receiving module 861 configured to receive a second event exposure notify message from a third network node. The second network node 860 may further comprise a first sending module 862 configured to send a first event exposure notify message to a first network node. The second event exposure notify message may comprise a user equipment (UE) Internet protocol (IP) address and an IP domain of the UE IP address. The first event exposure notify message may comprise the UE IP address and the IP domain of the UE IP address.

In an embodiment, the second network node 860 may further comprise a second receiving module 863 configured to receive a first event exposure subscribe request for protocol data unit (PDU) session status from the first network node.

In an embodiment, the second network node 860 may further comprise a second sending module 864 configured to send a second event exposure subscribe request for the PDU session status to a fourth network node.

In an embodiment, the second network node 860 may further comprise a third receiving module 865 configured to receive a second event exposure subscribe response from the fourth network node.

In an embodiment, the second network node 860 may further comprise a third sending module 866 configured to send a first event exposure subscribe response to the first network node.

In an embodiment, the second network node 860 may further comprise a fourth receiving module 867 configured to receive an application function (AF) session with quality of service (QoS) create request from the first network node. The AF session with QoS create request may comprise the UE IP address, the IP domain of the UE IP address, and an application function IP address.

In an embodiment, the second network node 860 may further comprise a fourth sending module 868 configured to send a policy authorization create request to a policy control function. The policy authorization create request may comprise the UE IP address, the IP domain of the UE IP address, and an application function IP address.

FIG. 8d is a block diagram showing a fourth network node according to another embodiment of the disclosure. As shown, the fourth network node 870 may comprise a first receiving module 871 configured to receive a second event exposure subscribe request for the PDU session status from a second network node. The fourth network node 870 may further comprise a first sending module 872 configured to send a second event exposure subscribe response to the second network node. The second event exposure subscribe request may comprise an indication of IP domain needed.

In an embodiment, the fourth network node 870 may further comprise a second sending module 873 configured to send a third event exposure subscribe request for the PDU session status to a third network node. The third event exposure subscribe request may comprise an indication of IP domain needed.

In an embodiment, the fourth network node 870 may further comprise a second receiving module 874 configured to receive third event exposure subscribe response from the third network node. The third event exposure subscribe request may comprise an indication of IP domain needed.

FIG. 9 is a block diagram showing a third network node according to another embodiment of the disclosure. As shown, the third network node 900 may comprise a first sending module 901 configured to send a second event exposure notify message to a second network node. The second event exposure notify message may comprise a user equipment (UE) Internet protocol (IP) address and an IP domain of the UE IP address.

In an embodiment, the third network node 900 may further comprise a receiving module 902 configured to receive a third event exposure subscribe request for protocol data unit (PDU) session status from a fourth network node.

In an embodiment, the third network node 900 may further comprise a second sending module 903 configured to send a third event exposure subscribe response to the fourth network node.

With function units, the first network node, the second network node, the third network node, or the fourth network node may not need a fixed processor or memory, any computing resource and storage resource may be arranged from the first network node, the second network node, the third network node, or the fourth network node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Further, the exemplary overall commutation system including the terminal device and the network node will be introduced as below.

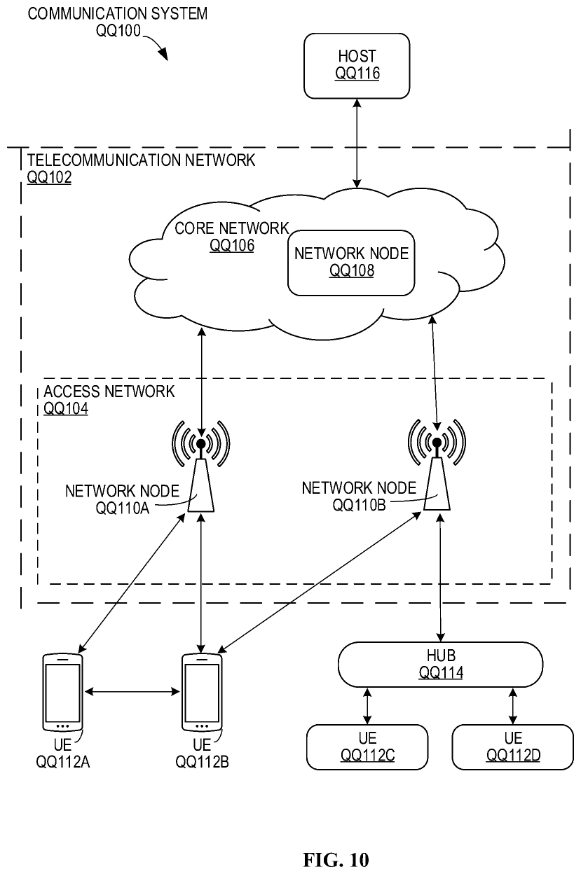

FIG. 10 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

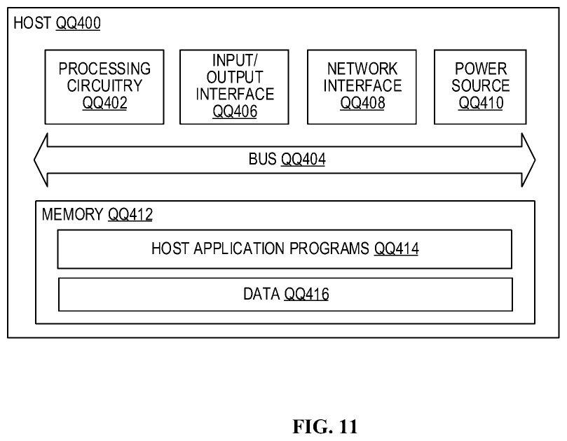

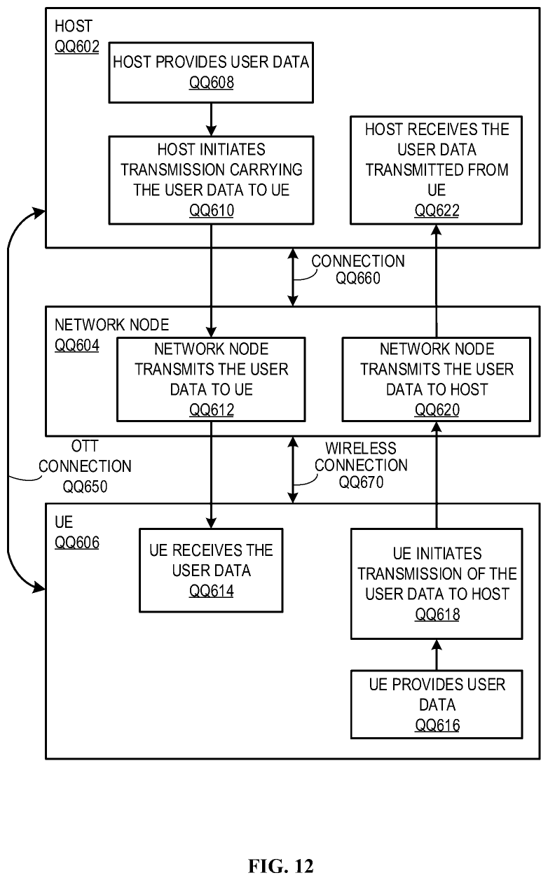

FIG. 11 is a block diagram of a host QQ400, which may be an embodiment of the host QQ116 of FIG. 10, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 10 and/or UE QQ200 of FIG. QQ2), network node (such as network node QQ110a of FIG. 10 and/or network node QQ300 of FIG. QQ3), and host (such as host QQ116 of FIG. 10 and/or host QQ400 of FIG. 11) discussed in the preceding paragraphs will now be described with reference to FIG. 12.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 10) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the NEF Event Exposure capability to include an indication of IP_domain_needed for PDU session status event. IP domain is necessary for NEF to apply the required QoS for an IP flow when overlapping private address range is used. In some embodiments herein, it may enhance 3GPP procedure to instruct SMF to include the IP domain of UE IP address, which is essential for NEF to be able to complete SessionWithQoS API operation.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.
Embodiment 1. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform the operations related to the wireless device as described above to transmit the user data from the host to the UE:
Embodiment 2. The host of the previous embodiment, wherein:
   the processing circuitry of the host is configured to execute a host application that provides the user data; and
   the UE comprises processing circuitry configured to execute a client application associated with the host application to receive the transmission of user data from the host.
Embodiment 3. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs the operations related to the wireless device as described above to transmit the user data from the host to the UE:
Embodiment 4. The method of the previous embodiment, further comprising, at the network node, transmitting the user data provided by the host for the UE.
Embodiment 5. The method of any of the previous 2 embodiments, wherein the user data is provided at the host by executing a host application that interacts with a client application executing on the UE, the client application being associated with the host application.
Embodiment 6. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform the operations related to the wireless device as described above to transmit the user data from the host to the UE:
Embodiment 7. The communication system of the previous embodiment, further comprising:
   the network node; and/or
   the user equipment.
Embodiment 8. The communication system of the previous 2 embodiments, wherein:
   the processing circuitry of the host is configured to execute a host application, thereby providing the user data; and
   the host application is configured to interact with a client application executing on the UE, the client application being associated with the host application.
Embodiment 9. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform the operations related to the wireless device as described above to receive the user data from the UE for the host:
Embodiment 10. The host of the previous 2 embodiments, wherein:
   the processing circuitry of the host is configured to execute a host application, thereby providing the user data; and
   the host application is configured to interact with a client application executing on the UE, the client application being associated with the host application.
Embodiment 11. The host of the any of the previous 2 embodiments, wherein the initiating receipt of the user data comprises requesting the user data.
Embodiment 12. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs the operations related to the wireless device as described above to receive the user data from the UE for the host:
Embodiment 13. The method of the previous embodiment, further comprising at the network node, transmitting the received user data to the host.
Embodiment 14. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform the operations related to the wireless device as described above to receive the user data from the host:
Embodiment 15. The host of the previous embodiment, wherein the cellular network further includes a network node configured to communicate with the UE to transmit the user data to the UE from the host.
Embodiment 16. The host of the previous 2 embodiments, wherein:
   the processing circuitry of the host is configured to execute a host application, thereby providing the user data; and
   the host application is configured to interact with a client application executing on the UE, the client application being associated with the host application.
Embodiment 17. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs the operations related to the wireless device as described above to receive the user data from the host:
Embodiment 18. The method of the previous embodiment, further comprising:
   at the host, executing a host application associated with a client application executing on the UE to receive the user data from the UE.
Embodiment 19. The method of the previous embodiment, further comprising:
   at the host, transmitting input data to the client application executing on the UE, the input data being provided by executing the host application,
   wherein the user data is provided by the client application in response to the input data from the host application.
Embodiment 20. A host configured to operate in a communication system to provide an over-the-top (OTT) service, the host comprising:
   processing circuitry configured to utilize user data; and
   a network interface configured to receipt of transmission of the user data to a cellular network for transmission to a user equipment (UE),
   wherein the UE comprises a communication interface and processing circuitry, the communication interface and processing circuitry of the UE being configured to perform the operations related to the wireless device as described above to transmit the user data to the host:
Embodiment 21. The host of the previous embodiment, wherein the cellular network further includes a network node configured to communicate with the UE to transmit the user data from the UE to the host.
Embodiment 22. The host of the previous 2 embodiments, wherein:
   the processing circuitry of the host is configured to execute a host application, thereby providing the user data; and
   the host application is configured to interact with a client application executing on the UE, the client application being associated with the host application.
Embodiment 23. A method implemented by a host configured to operate in a communication system that further includes a network node and a user equipment (UE), the method comprising:
   at the host, receiving user data transmitted to the host via the network node by the UE, wherein the UE performs the operations related to the wireless device as described above to transmit the user data to the host:
Embodiment 24. The method of the previous embodiment, further comprising:
   at the host, executing a host application associated with a client application executing on the UE to receive the user data from the UE.
Embodiment 25. The method of the previous embodiments, further comprising:
   at the host, transmitting input data to the client application executing on the UE, the input data being provided by executing the host application,
   wherein the user data is provided by the client application in response to the input data from the host application.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first network node, comprising:
receiving first event exposure notify message from a second network node, wherein
the first event exposure notify message comprises a user equipment (UE) Internet protocol (IP) address and an IP domain of the UE IP address.

2. The method of claim 1, further comprising:
sending a first event exposure subscribe request for protocol data unit (PDU) session status to the second network node; and
receiving a first event exposure subscribe response from the second network node.

3. The method of claim 2, wherein the first event exposure subscribe request comprises an indication of IP domain needed.

4. The method of claim 1, further comprising:
sending an application function (AF) session with quality of service (QoS) create request to the second network node, wherein
the AF session with QoS create request comprises the UE IP address, the IP domain of the UE IP address, and an application function IP address.

5. The method of claim 1, wherein
the first network node comprises an application function (AF) and/or an edge enabler server (EES), and/or
the second network node comprises a network exposure function.

6. (canceled)

7. The method of claim 1, wherein
the UE IP address comprises an IP private address, and/or
a same IP address can be allocated to two or more PDU sessions in different IP address domains.

8. (canceled)

9. A method performed by a second network node, comprising:
receiving a second event exposure notify message from a third network node; and
sending a first event exposure notify message to a first network node, wherein the second event exposure notify message comprises a user equipment (UE) Internet protocol (IP) address and an IP domain of the UE IP address, and
the first event exposure notify message comprises the UE IP address and the IP domain of the UE IP address.

10. The method of claim 9, further comprising:
receiving a first event exposure subscribe request for protocol data unit (PDU) session status from the first network node;
sending a second event exposure subscribe request for the PDU session status to a fourth network node;
receiving a second event exposure subscribe response from the fourth network node; and
sending a first event exposure subscribe response to the first network node.

11. The method of claim 10, wherein
the first event exposure subscribe request comprises an indication of IP domain needed, and/or
the second event exposure subscribe request comprises an indication of IP domain needed.

12. The method of claim 10, further comprising:
receiving an application function (AF) session with quality of service (QoS) create request from the first network node; and
sending a policy authorization create request to a policy control function, wherein
the AF session with QoS create request comprises the UE IP address, the IP domain of the UE IP address, and an application function IP address, and
the policy authorization create request comprises the UE IP address, the IP domain of the UE IP address, and an application function IP address.

13. The method of claim 10, wherein
the first network node comprises an application function (AF) and/or an edge enabler server (EES),
the second network node comprises a network exposure function,
the third network node comprises a session management function, and/or
the fourth network node comprises a unified data management (UDM).

14-16. (canceled)

17. The method of claim 10, wherein
the UE IP address comprises an IP private address, and/or
a same IP address can be allocated to two or more PDU sessions in different IP address domains.

18. (canceled)

19. A method performed by a fourth network node, comprising:
receiving a second event exposure subscribe request for the PDU session status from a second network node; and
sending a second event exposure subscribe response to the second network node, wherein
the second event exposure subscribe request comprises an indication of IP domain needed.

20. The method of claim 19, further comprising:
sending a third event exposure subscribe request for the PDU session status to a third network node; and
receiving third event exposure subscribe response from the third network node, wherein
the third event exposure subscribe request comprises an indication of IP domain needed.

21. The method of claim 20, wherein the third network node comprises a session management function.

22. The method of claim 19, wherein
the second network node comprises a network exposure function, and/or
the fourth network node comprises a unified data management (UDM).

23-41. (canceled)
